(19) United States
(12) Patent Application Publication
(10) Pub. No.: US 2018/0119942 A1
(43) Pub. Date: May 3, 2018

(54) LIGHTING DEVICE

(71) Applicant: ASTER CO., LTD., Yokote-shi, Akita (JP)

(72) Inventor: Takenobu HONGO, Fukushima (JP)

(73) Assignee: ASTER CO., LTD., Yokote-shi, Akita (JP)

(21) Appl. No.: 15/565,579

(22) PCT Filed: Feb. 24, 2016
(86) PCT No.: PCT/JP2016/055460

§ 371 Date: Oct. 10, 2017

(30) Foreign Application Priority Data
Apr. 20, 2015 (JP) 2015-086041

(51) Int. Cl. F21V 31/00; F21V 3/02; F21V 29/71; F21V 29/89; F21S 8/04

(52) U.S. Cl. CPC F21V 31/005; F21V 3/02; F21Y 2115/10; F21V 29/89; F21S 8/04; F21V 29/717

(57) ABSTRACT

It is an object to provide a lighting device having a simple configuration and excellent in waterproofing function. A lighting device includes a housing including a flat portion and an annular peripheral wall portion which is continuous from a periphery of the flat portion to a rear side, a light source which is arranged on the flat portion, and an optically transparent light source cover which is placed on the flat portion and covers a light-emitting surface of the light source.

### CROSS-REFERENCE TO RELATED APPLICATIONS

This application is a U.S. National Stage Application of International Patent Application No. PCT/JP2016/055460, filed on Feb. 24, 2016, which claims priority to Japanese Application No. 2015-086041 filed on Apr. 20, 2015, which are hereby incorporated by reference in the present disclosure in its entirety.

### FIELD OF THE INVENTION

The present invention relates to a lighting device for applying light.

### BACKGROUND OF THE INVENTION

A lighting device using an LED light source element and the like is lightweight, is shock-resistant, and has a long life and is currently used as a light source in various places, such as a house, a factory, an agricultural facility, and a dairy facility.

Depending on usage environment, a lighting device of this type is expected to have a waterproofing function. For example, in a chicken farm, a ceiling and inner walls need to be periodically cleaned with water. A waterproofing function of a conventional lighting device is implemented by placing the whole of a board having an LED light source element mounted thereon in an airtight housing (see, for example, Patent Literature 1).

### Patent Literature

[Patent Literature 1]: Japanese Patent Laid-Open No. 2014-191984

### BRIEF SUMMARY OF THE INVENTION

However, if an LED light source element and a board are placed in an airtight housing, heat generated from the board and the LED light source element is likely to stay inside.

Additionally, use of an airtight housing in a lighting device increases manufacturing cost and, at the same time, takes a lot of trouble with the work of assembling the device.

From a safety perspective, a lighting device arranged at a high place, such as on a ceiling, is strongly requested to decrease not only in size but also in weight. A conventional lighting device needs an airtight housing, which involves an increase in weight.

In view of the above-described circumstances, the present invention has as its object to provide a lighting device which has a simple structure and achieves both high waterproof performance and a heat-releasing function.

According to the present invention, there is provided a lighting device including a housing including a flat portion, on which a light source is to be arranged, and an annular peripheral wall portion which is continuous from a periphery of the flat portion to a rear side, a light source which is arranged on the flat portion of the housing, and an optically transparent light source cover which is placed on the flat portion of the housing to cover a light-emitting surface of the light source.

In connection with the above-described lighting device, a feature of the present invention is that a plurality of light sources constituting the light source are arranged on the flat portion, and the light source cover is arranged for each of the light sources.

In connection with the above-described lighting device, a feature of the present invention is that an annular light-source-cover-side sealing member is arranged between the light source cover and the flat portion.

In connection with the above-described lighting device, a feature of the present invention is that the light source cover covers a part of the flat portion, and a remainder of the flat portion is exposed to outside air.

In connection with the above-described lighting device, a feature of the present invention is that an annular housing-side sealing member is arranged along a rear-side end edge in the peripheral wall portion of the housing.

In connection with the above-described lighting device, a feature of the present invention is that a heat receiving and releasing member is arranged on a reverse side of the flat portion.

In connection with the above-described lighting device, a feature of the present invention is that the heat receiving and releasing member is configured to include an expanded graphite layer containing expanded graphite, and a metal layer in contact with the expanded graphite layer and made of metal.

In connection with the above-described lighting device, a feature of the present invention is that the heat receiving and releasing member has a plate shape and is arranged in contact with a reverse of the flat portion.

In connection with the above-described lighting device, a feature of the present invention is that the lighting device includes a plate-shaped rear cover which covers at least a part of the heat receiving and releasing member on a rear side of the heat receiving and releasing member.

In connection with the above-described lighting device, a feature of the present invention is that the heat receiving and releasing member and the rear cover are arranged at a distance from each other, and a connection member which connects the heat receiving and releasing member and the rear cover is provided.

In connection with the above-described lighting device, a feature of the present invention is that the lighting device includes, as the heat receiving and releasing member, plate-shaped first and second heat receiving and releasing members which are parallel to the flat portion and are arranged at a distance from each other, and a connection member which connects the first and second heat receiving and releasing members is provided.

In connection with the above-described lighting device, a feature of the present invention is that the connection member includes an expanded graphite layer for connection containing expanded graphite.

In connection with the above-described lighting device, a feature of the present invention is that the connection member is formed by winding, into tube form, an expanded graphite sheet obtained by molding expanded graphite into sheet form.

According to the present invention, it is possible to obtain a lighting device having a simple structure and high in waterproofness and heat releasability.

### BRIEF DESCRIPTION OF THE DRAWINGS

FIGS. 1(A), 1(B), 1(C), and 1(D) are a plan view, a right side view, a bottom view, and a front elevational view, respectively, of a lighting device according to an embodiment of the present invention.

FIG. 2(A) is a cross-sectional view of the lighting device taken along arrows II-II in FIG. 1(A), and FIG. 2(B) is a partial enlarged cross-sectional view of the lighting device.

FIG. 3(A) is a cross-sectional view showing, on an enlarged scale, a heat receiving and releasing member and a connection member of the lighting device, and FIG. 3(B) is a perspective view showing, on an enlarged scale, the connection member.

FIGS. 4(A) to 4(D) are schematic views showing a method for manufacturing the connection member.

FIG. 5 is a cross-sectional view showing another configuration example of the lighting device.

### DETAILED DESCRIPTION OF THE INVENTION

A lighting device 1 according to an embodiment of the present invention will be described below with reference to the accompanying drawings.

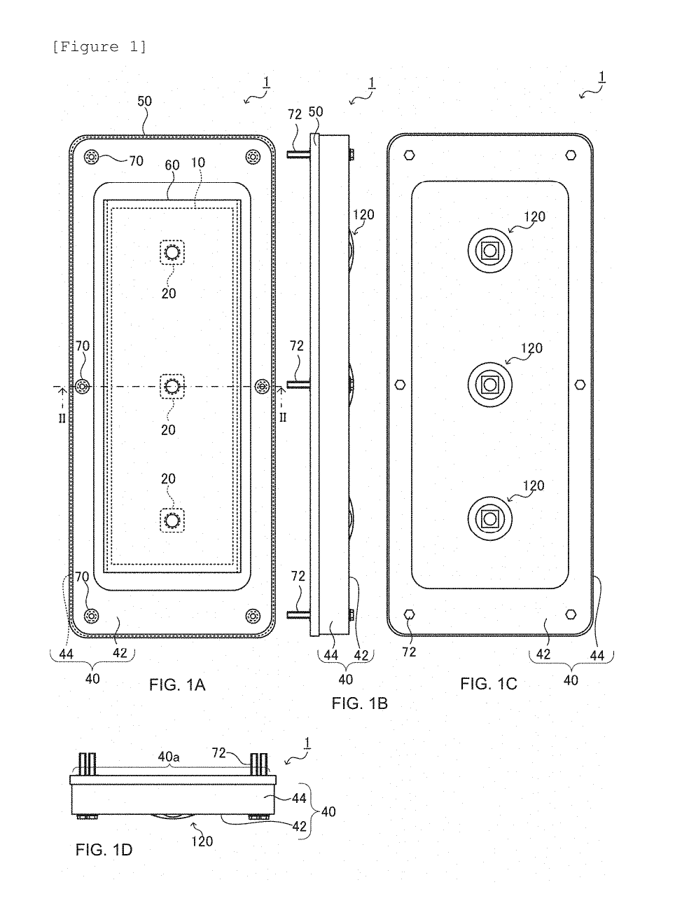

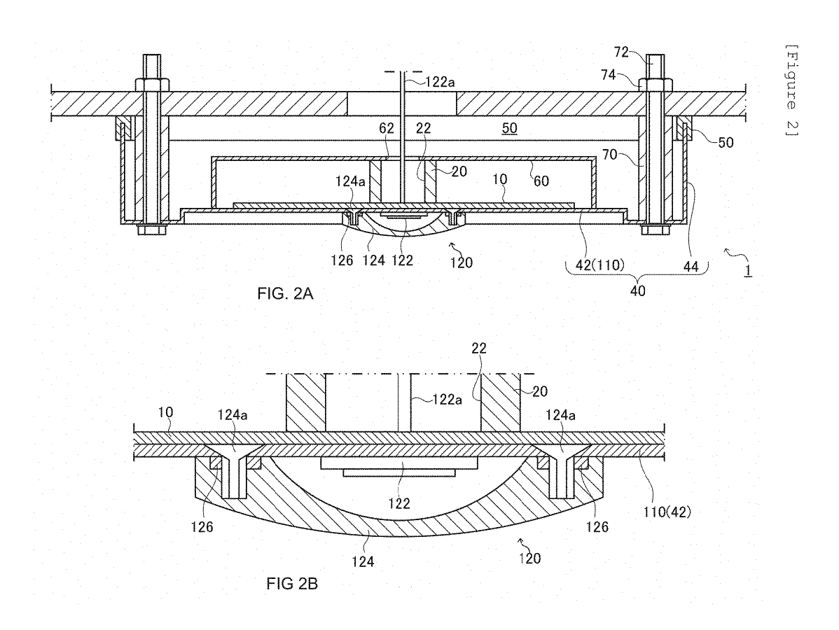

FIG. 1(A) is a plan view of the lighting device 1, FIG. 1(B) is a right side view, FIG. 1(C) is a bottom view, and FIG. 1(D) is a front elevational view. FIG. 2(A) is a cross-sectional view taken along arrows II-II in FIG. 1(A), and FIG. 2(B) is a partial enlarged view. Note that, in the present embodiment, a lower side and an upper side in FIG. 2(A) are defined as a front side (a side where light is emitted) and a rear side (a side where no light is emitted), respectively, in the lighting device 1.

The lighting device 1 is configured to include a plurality of (three) LED modules 120 as a light source, a housing 40 doubling as a board 110 on which the LED modules 120 are to be placed, a heat receiving and releasing member 10, a connection member 20, a rear cover 60, and the like.

The housing 40 is wide open on one side (the upper side in FIG. 2(A)) which is a side with a surface to be placed on, e.g., a wall surface or a ceiling and is approximately box-shaped. More specifically, the housing 40 has a flat portion 42 on which the LED modules 120 are to be placed and an annular peripheral wall portion 44 which is continuous from a periphery of the flat portion 42 to the rear side. Since the flat portion 42 has the shape of a rectangle, the peripheral wall portion 44 is composed of four surfaces which are continuous from edges of the rectangle. The flat portion 42 doubles as the board 110, on which the LED modules 120 are to be placed. Note that the flat portion 42 may be configured to have a circular shape, an elliptical shape, or the like.

A housing-side sealing member 50 is placed at a rim of an opening 40a in the housing 40, i.e., a rear-side end edge (an edge) in the peripheral wall portion 44. The housing-side sealing member 50 is grooved rubber packing made of, e.g., silicon or synthetic rubber and is U-shaped in cross-section (see FIG. 2(A)). The edge of the opening 40a is fit in a groove of the housing-side sealing member 50.

As shown, on an enlarged scale, in FIG. 2(B), the LED module 120 has an LED light source element 122, a light source cover 124, and a light-source-cover-side sealing member 126. The LED light source element 122 is a high-brightness LED bulb, and is supplied with power from wiring 122a to emit light. The light source cover 124 is made of, e.g., resin or a glass material having optical transparency and is fixed to the board 110 (the flat portion 42 of the housing 40) with screws 124a. The light source cover 124 covers a light-emitting surface of the LED light source element 122. The light source cover 124 has an outer surface convex in a light emission direction of the LED light source element 122 and an inner surface concave in the light emission direction. With this configuration, the light source cover 124 plays a role in diffusing light from the LED light source element 122.

The light-source-cover-side sealing member 126 is ring-shaped rubber packing and is held sandwiched between the light source cover 124 and the board 110. This configuration prevents water or gas from entering into the inside (the LED light source element 122 side) through a gap between the light source cover 124 and the board 110. As a result, the LED light source element 122 is waterproof and explosion-proof. The light source cover 124 covers a part of the board 110 and, at the same time, exposes the remainder to outside air. Thus, heat from the board 110 can be directly released into outside air on a front surface side without being interrupted by the light source cover 124. The area of a portion covered by the light source cover 124 of the board 110 (the flat portion 42) is preferably set to be less than 30% of the total area, more preferably less than 20%. Although the details will be described later, it is desirable that the heat receiving and releasing member 10 be arranged on a reverse surface (rear surface) of the remainder (an inner surface of the housing 40) that is not covered by the light source cover 124 in the board 110 to sufficiently diffuse heat.

The heat receiving and releasing member 10 is intended to receive heat generated by the LED module 120 (performs heat reception), diffuse the heat, and release the heat into the air (performs heat release). The heat receiving and releasing member 10 is configured to have the shape of an approximately rectangular flat plate. In the present embodiment, the heat receiving and releasing member 10 is arranged in close contact with a reverse surface (rear surface) side of the flat portion 42 (the board 110) of the housing 40 (an inner side of the housing 40).

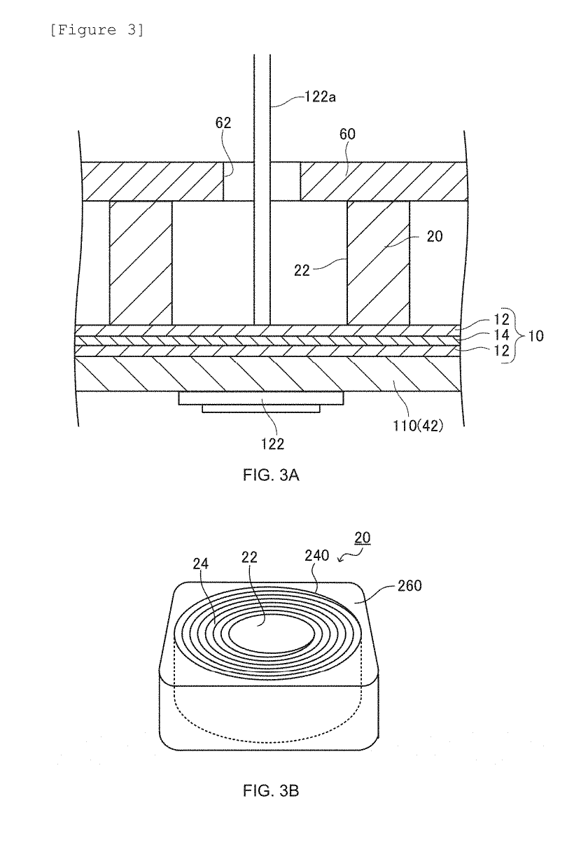

As shown in FIG. 3(A), the heat receiving and releasing member 10 includes two expanded graphite layers 12 made of expanded graphite and also includes a metal layer 14 made of metal between the two expanded graphite layers 12. That is, the heat receiving and releasing member 10 is configured to have a three-layer structure having the expanded graphite layer 12 as an outermost layer. The expanded graphite layers 12 and the metal layer 14 spread so as to cross (be approximately orthogonal to) a direction away from the LED module 120. Thus, the expanded graphite layer 12 is in contact with the board 110. The heat receiving and releasing member 10 is provided with the expanded graphite layer 12 having flexibility as the outermost layer, which allows the heat receiving and releasing member 10 to be easily brought into close contact with a different member. As a result, efficient heat transmission from the board 110 having the LED module 120 arranged thereon to the heat receiving and releasing member 10 is possible.

The above-described configuration can be expressed as a state in which the heat receiving and releasing member 10 is made to double as the board 110. In this case, the expanded graphite layer 12 may be directly stacked on, for example, an inner side (reverse side) of the board 110. Alternatively, the heat receiving and releasing member 10 may be made to double as the board 110 by configuring the heat receiving and releasing member 10 to have a three-layer structure with the expanded graphite layer 12, the board 110, and the expanded graphite layer 12 stacked in this order and adding a reflecting layer for reflecting light or a protective layer for protecting the expanded graphite layer 12 which is made of, e.g., metal or resin as an outermost layer.

In the present embodiment, the heat receiving and releasing member 10 is formed by overlaying two expanded graphite sheets on two sides of a metal sheet and compressively bonding the sheets through pressing or the like. The expanded graphite sheets are obtained by compressively molding, into sheet form, expanded graphite powder that is expanded through rapid heating of graphite powder with an intercalation compound generated using a strong acid, such as sulfuric acid or nitric acid.

An expanded graphite sheet has the property of being low in heat conductivity in a thickness direction but being very high in heat conductivity in a planar direction. Graphite contained in an expanded graphite sheet has the property of being high in heat emissivity and heat absorptivity. Although the details will be described later, the properties of an expanded graphite sheet are effectively utilized in the present embodiment, which allows efficient heat release from the LED module 120. Additionally, the metal layer 14 is provided in the heat receiving and releasing member 10 together with the expanded graphite layer 12 in the present embodiment. With this provision, the heat receiving and releasing member 10 has appropriate strength and rigidity despite the use of an expanded graphite sheet which is a relatively fragile material.

Note that the expanded graphite layer 12 may, of course, contain various binders or the like in addition to expanded graphite. Alternatively, for example, various metals or the like for adjusting heat conductivity in a thickness direction may be mixed. The type of a metal, of which the metal layer 14 is made, is not particularly limited. The metal is preferably a metal high in heat conductivity, such as aluminum or copper, or an alloy. In terms of weight and cost, aluminum or an aluminum alloy is preferable.

Note that the shape and size of the heat receiving and releasing member 10 and the number of heat receiving and releasing members 10 are not particularly limited and may be appropriately set in accordance with, e.g., the amount of heat generated by the LED modules 120 and the number of LED modules 120. For example, a hole extending in a thickness direction may be provided in the heat receiving and releasing member 10 to adjust an air flow.

The connection member 20 is arranged between the board 110 (the heat receiving and releasing member 10) and the rear cover 60, connects the board 110 and the rear cover 60, and functions as a spacer for arrangement with an appropriate interval. The connection member 20 also functions as a heat transmission member which transmits heat from the heat receiving and releasing member 10 to the rear cover 60 by being in contact with the heat receiving and releasing member 10. The connection member 20 is arranged on a rear side of each of the plurality of LED modules 120. As shown in FIG. 3(B), the connection member 20 has the shape of a tube having a through-hole 22 at a central portion. The through-hole 22 is formed such that the wiring 122a of the LED module 120 is inserted into the through-hole 22. A through-hole 62 for insertion of the wiring 122a is provided at a predetermined position of the rear cover 60. Note that various methods, such as bonding, engagement, or screw fastening with bolts or nuts, can be adopted as a method for placing the connection member 20.

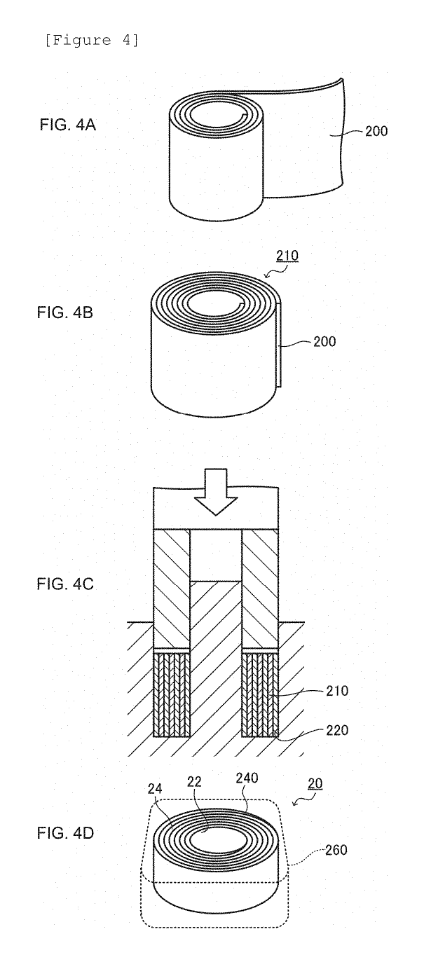

As described above, the connection member 20 functions as a spacer and as a heat transmission member. Thus, in the present embodiment, heat transmission in the connection member 20 is facilitated by forming the connection member 20 from an approximately coil-shaped (tube-shaped) roll of expanded graphite tape obtained by compressively molding expanded graphite into belt form. FIGS. 4(A) to 4(D) are schematic views showing a method for manufacturing the connection member 20.

In the manufacture of the connection member 20, as shown in FIG. 4(A), expanded graphite tape 200 which is an approximately belt-shaped expanded graphite sheet is wound into coil form. As shown in FIG. 4(B), a material 210 is formed. As shown in FIG. 4(C), the material 210 is pressed in an axial direction while the material 210 is fit in a cylindrical mold 220 which is set to have a predetermined inner diameter and a predetermined outer diameter. With this operation, the wound expanded graphite tape 200 is compressively bonded into spiral form. As shown in FIG. 4(D), an expanded graphite cylindrical member 240 which is compressively molded into approximately cylindrical form is obtained. The connection member 20 is completed by arranging a protective member 260 on an outer periphery of the cylindrical member 240. Note that the protective member 260 is omitted from the connection member 20.

The expanded graphite tape 200 (i.e., an expanded graphite sheet) has the property of being excellent in heat conductivity in a planar direction. Since the expanded graphite tape 200 can be compressively molded into approximately cylindrical form with a direction, in which the heat conductivity of the expanded graphite tape 200 is excellent, set to an axial direction, the heat conductivity in an axial direction (a vertical direction in FIG. 4(D)) of the connection member 20 can be enhanced by forming the connection member 20 from the expanded graphite tape 200 thus wound in spiral form. That is, heat can be quickly transferred in the axial direction by the spiral expanded graphite layer 24, and heat transmission from the heat receiving and releasing member 10 to the rear cover 60 via the connection member 20 can be facilitated.

Note that the shape of the connection member 20 is not limited to a tubular shape and may be any other shape. Since the expanded graphite layer 12 of the heat receiving and releasing member 10 is susceptible to injury due to contact with the wiring 122a and the like, covering the periphery of the wiring 122a with the connection member 20 allows protection of the heat receiving and releasing member 10. The expanded graphite tape 200 used to manufacture the connection member 20 may contain various binders, metal, or the like in addition to expanded graphite and may include a metal layer for reinforcement, a resin layer, or the like.

The connection member 20 may be made of any other material that is a metal high in heat conductivity, such as aluminum or copper, an alloy, or the like. A position where the connection member 20 is to be arranged and the number of connection members 20 are not particularly limited and may be appropriately set in accordance with the shape, the size, and the like of the heat receiving and releasing member 10.

As shown in FIG. 2, the rear cover 60 is a member U-shaped in cross section which is formed by bending two ends of a metal plate toward the front side at an angle of 90 degrees. The rear cover 60 is arranged at a distance on a rear side of the heat receiving and releasing member 10 and covers at least a part of the heat receiving and releasing member 10. This inhibits a hand of a worker or the wiring 122a from coming into contact with the heat receiving and releasing member 10 to damage the expanded graphite layer 12 at the time of transport, placement, or the like of the lighting device 1. The rear cover 60 also has a function of diffusing heat transmitted from the connection member 20 and releasing the heat into the air (i.e., a function of a heat receiving and releasing member).

Six approximately cylindrical supports 70 which extend front to back are arranged around and inside the housing 40. The length of the support 70 is set to be equal to or less than a length in the same direction of the peripheral wall portion 44 of the housing 40. The lighting device 1 is fixed to a member on the other end, such as a ceiling, with male screws 72 and/or female screws 74 which are fastened to the supports 70. Thus, as shown in FIG. 2(A), close contact of the housing-side sealing member 50 with the member on the other end fills a gap between the member on the other end (the ceiling) and the housing 40, and water or the like is prevented from entering into the housing 40.

As has been described above, in the lighting device 1 according to the present embodiment, the light source cover 124 that covers a light-emitting surface is arranged for each of the plurality of LED light source elements 122 placed on the flat portion 42 of the housing 40. The annular light-source-cover-side sealing member 126 is arranged between the light source cover 124 and the flat portion 42. As a result, the LED light source element 122 can be made waterproof and/or explosion-proof. Since the light source cover 124 and the light-source-cover-side sealing member 126 are arranged for each LED light source element 122, the range of sealing with the light-source-cover-side sealing members 126 is reduced, and a waterproofing function and the like can be improved. Additionally, waterproofness can be achieved at low cost.

In the lighting device 1, the annular housing-side sealing member 50 is arranged along the rear-side end edge in the peripheral wall portion 44 of the housing 40. The lighting device 1 is fixed with the screws 72, the supports 70, and the like while the housing-side sealing member 50 is brought into close contact with the member on the other end, such as the ceiling, which allows achievement of rear-side waterproofness with a simple configuration. Heat inside the housing 40 is also released from the member on the other end, such as the ceiling. The reason why heat release is implemented by forming the opening 40a on a rear side of the housing 40 and a simple waterproof structure using the housing-side sealing member 50 can be adopted is because the LED light source element 122 is arranged on an outer surface of the flat portion 42 of the housing 40, and an individual waterproofing function and the like are separately implemented by the light source cover 124, as described earlier. That is, the housing-side sealing member 50 has an auxiliary waterproofing function. Thus, even if the lighting device 1 is placed in a place which needs periodic cleaning of a side wall (e.g., a ceiling), such as a chicken farm or a food factory, a sufficient waterproofing function can be implemented.

The lighting device 1 also includes the heat receiving and releasing member 10. Heat generated by the LED light source element 122 is thus transmitted to the heat receiving and releasing member 10 via the board 110. Since the board 110 and the heat receiving and releasing member 10 are in close contact in the present embodiment, heat can be efficiently transferred from the board 110 to the heat receiving and releasing member 10. The expanded graphite layer 12 that is in contact with the board 110 in the heat receiving and releasing member 10 is excellent in heat emissivity and absorptivity. Adoption of a material which appropriately transmits electromagnetic waves as the material for the board 110 allows transfer of sufficient heat to the heat receiving and releasing member 10 through heat emission.

Heat transferred to the heat receiving and releasing member 10 diffuses and transfers mainly in a planar direction (a horizontal direction in FIG. 3(A)) due to a difference in heat conductivity between a planar direction and a thickness direction of the expanded graphite layer 12 as the outermost layer. The heat transfers gradually in a thickness direction (a vertical direction in FIG. 3(A)) while diffusing and transferring in the planar direction, and a part of the heat returns to the board 110 and is released to the outside. That is, the heat release performance of the board 110 itself can be enhanced. Another part of the heat arrives at the expanded graphite layer 12 that is a surface on the opposite side of the heat receiving and releasing member 10 from the LED light source element 122. A part of the heat arriving at the expanded graphite layer 12 transfers toward air in contact with the expanded graphite layer 12. Since the expanded graphite layer 12 is excellent in heat emissivity, as described above, the part of the heat transfers to neighboring air through heat emission. For this reason, a part of heat generated by the LED light source element 122 is also released into air inside the housing 40. The heat is released from the member on the other end, such as the ceiling.

In a portion in contact with the connection member 20 of the heat receiving and releasing member 10, heat transfers to the connection member 20. The heat transferred to the connection member 20 transfers quickly in the axial direction due to the expanded graphite layer 24 and is transmitted to the rear cover 60. The heat transferred to the rear cover 60 diffuses quickly in a planar direction, as in the heat receiving and releasing member 10. After that, a part of the heat is released into the air. That is, the rear cover 60 can also be made to function as a second heat receiving and releasing member.

As described above, in the present embodiment, it is possible not only to quickly diffuse heat in the planar direction in one heat receiving and releasing member 10 but also to transmit heat to the housing 40 and the rear cover 60 in succession through heat transmission via the connection member 20 and heat transmission by heat emission from an obverse of the heat receiving and releasing member 10. Since heat generated by the LED light source element 122 can be transmitted in various ways, emission of heat into the air can be efficiently performed.

Additionally, in the present embodiment, planar directions of the board 110 and the heat receiving and releasing member 10 are made to coincide, and the board 110 and the heat receiving and releasing member 10 are brought into contact with each other. This makes it possible to release heat into the air while actively keeping the heat away from the LED light source element 122 in the planar directions. A situation in which heat release efficiency decreases due to, e.g., a stay of heat in the neighborhood of the LED light source element 122 can be prevented. As the result, since a blower fan, a heatsink, and the like can be omitted, the lighting device 1 can be made more lightweight and compact. Note that, to facilitate heat transmission through heat emission, a material high in heat emissivity or heat absorptivity, such as heat emissive paint, may be applied to an obverse side of the expanded graphite layer 12 or the obverse side may be impregnated with the material. That is, the expanded graphite layer 12 may have a coating containing a material high in heat emissivity or heat absorptivity on the obverse side.

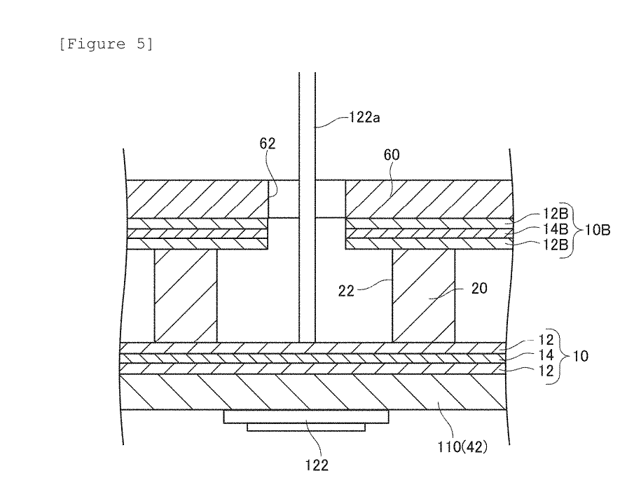

Note that although the embodiment has illustrated a case where the rear cover 60 functioning as a heat receiving and releasing member does not have the expanded graphite layer 12, the present invention is not limited to this. For example, as shown in FIG. 5, a second heat receiving and releasing member 10B may be separately arranged on a surface on the LED light source element 122 side of the rear cover 60 so as to be in surface contact. The second heat receiving and releasing member 10B has two expanded graphite layers 12B and a metal layer 14B arranged between the expanded graphite layers 12B, like the heat receiving and releasing member 10. With this configuration, heat transmitted via the connection member 20 is diffused in a planar direction by the second heat receiving and releasing member 10B, which allows efficient heat release. Since the heat receiving and releasing member 10 and the second heat receiving and releasing member 10B face each other, heat released from the heat receiving and releasing member 10 into the air can be absorbed by the second heat receiving and releasing member 10B, transmitted to the rear cover 60 side, and released. Heat release efficiency can be enhanced. Note that the second heat receiving and releasing member 10B itself can be used as a rear cover member.

### REFERENCE SIGNS LIST

1 lighting device
10 heat receiving and releasing member
10B second heat receiving and releasing member
12 expanded graphite layer
14 metal layer
20 connection member
22 through-hole
24 expanded graphite layer
40 housing
40a opening
42 flat portion
44 peripheral wall portion
50 housing-side sealing member
60 rear cover
62 through-hole
70 support
110 board
120 LED module
122 LED light source element
122a wiring
124 light source cover
126 light-source-cover-side sealing member

1. A lighting device comprising:
a housing including a flat portion, and an annular peripheral wall portion which is continuous from a periphery of the flat portion to a rear side;
a light source which is arranged on the flat portion of the housing; and
an optically transparent light source cover which is placed on the flat portion of the housing to cover a light-emitting surface of the light source.

2. The lighting device according to claim 1, wherein a plurality of light sources constituting the light source are arranged on the flat portion, and the light source cover is arranged for each of the light sources.

3. The lighting device according to claim 1, wherein an annular light-source-cover-side sealing member is arranged between the light source cover and the flat portion.

4. The lighting device according to claim 1, wherein the light source cover covers a part of the flat portion, and a remainder of the flat portion is exposed to outside air.

5. The lighting device according to claim 1, wherein an annular housing-side sealing member is arranged along a rear-side end edge in the peripheral wall portion of the housing.

6. The lighting device according to claim 1, wherein a heat receiving and releasing member is arranged on a reverse side of the flat portion.

7. The lighting device according to claim 5, wherein
the heat receiving and releasing member is configured to include
an expanded graphite layer containing expanded graphite, and
a metal layer in contact with the expanded graphite layer and made of metal.

8. The lighting device according to claim 6, wherein
the heat receiving and releasing member has a plate shape and is arranged in contact with a reverse of the flat portion.

9. The lighting device according to claim 6, wherein
the lighting device includes a plate-shaped rear cover which covers at least a part of the heat receiving and releasing member on a rear side of the heat receiving and releasing member.

10. The lighting device according to claim 9, wherein
the heat receiving and releasing member and the rear cover are arranged at a distance from each other, and
a connection member which connects the heat receiving and releasing member and the rear cover is provided.

11. The lighting device according to claim 6, wherein
the lighting device includes, as the heat receiving and releasing member, plate-shaped first and second heat receiving and releasing members which are parallel to the flat portion and are arranged at a distance from each other, and
a connection member which connects the first and second heat receiving and releasing members is provided.

12. The lighting device according to claim 10, wherein
the connection member includes an expanded graphite layer for connection containing expanded graphite.

13. The lighting device according to claim 12, wherein
the connection member is formed by winding, into tube form, an expanded graphite sheet obtained by molding expanded graphite into sheet form.
